(19) United States
(12) Patent Application Publication
(10) Pub. No.: US 2013/0264511 A1
(43) Pub. Date: Oct. 10, 2013

(54) COMPOSITE FOR SHIELDING BROADBAND ELECTROMAGNETIC WAVES

(71) Applicants: Byung Sam Choi, Suwon (KR); Kyong Hwa Song, Seoul (KR); Han Saem Lee, Ansan (KR); Jin Woo Kwak, Suwon (KR)

(72) Inventors: Byung Sam Choi, Suwon (KR); Kyong Hwa Song, Seoul (KR); Han Saem Lee, Ansan (KR); Jin Woo Kwak, Suwon (KR)

(73) Assignee: HYUNDAI MOTOR COMPANY, Seoul (KR)

(21) Appl. No.: 13/548,388

(22) Filed: Jul. 13, 2012

(30) Foreign Application Priority Data
Apr. 4, 2012 (KR) 10-2012-0035129

(51) Int. Cl. H01F 1/00; B82Y 40/00; B82Y 30/00

(52) U.S. Cl. 252/62.54; 977/783; 977/742; 977/762; 977/779; 977/840

(57) ABSTRACT

Disclosed is a composite material for shielding broadband electromagnetic waves and a method for its production. More particularly, a composite material for shielding broadband electromagnetic waves that absorbs low frequency electromagnetic waves and reflects high frequency electromagnetic waves is disclosed. The composite material for shielding broadband electromagnetic waves may be a polymer composite prepared by mixing a matrix composition including a matrix-forming polymer impregnated with a carbonaceous conductive nano material with a filler composite including a filler-forming polymer impregnated with a magnetic material. The magnetic material impregnated in the filler-forming polymer may be distributed in the matrix composite.

### CROSS-REFERENCE TO RELATED APPLICATION

This application claims under 35 U.S.C. §119(a) the benefit of Korean Patent Application No. 10-2012-0035129 filed Apr. 4, 2012, the entire contents of which are incorporated herein by reference.

### BACKGROUND

(a) Technical Field

The present disclosure relates to a composite material for shielding broadband electromagnetic waves, and a method for production thereof. More particularly, it relates to a composite material for shielding broadband electromagnetic waves that absorbs low frequency electromagnetic waves and reflects high frequency electromagnetic waves.

(b) Background Art

With recent rapid developments in and mass production of computers, electronics, communication devices, and the like, the generation of electromagnetic waves has increased. Further, as noise generated by electromagnetic waves in various frequencies ranges increases, electromagnetic disturbance between electronics occurs, and various other problems are caused.

Electronic equipment is applied to a variety of safety and convenience appliances in automobiles to provide driver and pedestrian safety. Further, customers' interest in such appliances has increased. Thus, there is a particular need for high reliability in shielding electromagnetic waves and inhibiting electromagnetic interference between electronic parts which may be caused when electronic parts and circuits used in the electronic equipment are highly powered, highly integrated, and multi-functionalized.

Conventionally, in electronic parts, a shielding circuit has been separately designed in order to shield electromagnetic waves, or electromagnetic waves have been hindered by ground.

A method of shielding electromagnetic waves by surrounding electronics with a metal housing has also been used to inhibit electromagnetic interference between electronics.

However, if electronics are surrounded with metal, manufacturing costs increase because expensive molds are required. Further, due to the additional weight of the metal, it becomes more difficult to manufacture lightweight automobiles for improving fuel efficiency.

Thus, research has been conducted on the development of a functional polymer as an alternate material for surrounding electronics to shield electromagnetic waves. In order to prepare a composite material for shielding electromagnetic waves using a polymeric material, a method of providing a polymeric material with electrical conductivity by mixing a conductive filler with the polymeric material has been used. Further, a method of absorbing electromagnetic waves by mixing a magnetic material that absorbs electromagnetic waves with a polymeric material has also been used.

If a polymer composite which is prepared by mixing a conductive material or a magnetic material with a polymeric material is used for shielding electromagnetic waves between electronics, extrusion molding or injection molding processes that are commonly used in molding polymers are generally conducted. By uniformly and efficiently distributing the conductive material or magnetic material in the polymeric material during such processes, a desired effect of shielding electromagnetic waves can be obtained.

However, it is difficult to uniformly distribute and disperse a conductive material or a magnetic material in a polymeric material during the extrusion and injection molding processes due to differences in their specific gravities, intrinsic attraction, and the like.

In particular, since specific gravity of the magnetic material is considerably different from that of the polymeric material, a lumping phenomenon of the magnetic material occurs during the extrusion and injection molding processes. As a result, the polymer composite only locally shielding electromagnetic waves, and the merits of the polymer composite as an electromagnetic shielding material considerably deteriorate.

In attempts to improve dispersibility, a variety of additives have been added to a polymeric material. However, manufacturing costs increase, and physical properties of the polymer composite deteriorate due to the additives.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art.

The present invention provides a composite material for shielding broadband electromagnetic waves that has excellent electromagnetic wave shielding capability in a broadband, particularly by absorbing low frequency electromagnetic waves and reflecting high frequency electromagnetic waves. In particular, the composite material can include a magnetic material and a carbonaceous conductive nano material, wherein the magnetic material absorbs low frequency electromagnetic waves, while the carbonaceous conductive nano material reflects high frequency electromagnetic waves.

In one aspect, the present invention provides a composite material for shielding broadband electromagnetic waves that comprises a mixture of a matrix composite and a filler composite. In particular, the matrix composite can be a composite material prepared by impregnating a matrix-forming polymer with a carbonaceous conductive nano material, and the filler composite can be a composite material prepared by impregnating a filler-forming polymer with a magnetic material. According to various embodiments, the magnetic material impregnated in the filler-forming polymer is distributed in the matrix composite.

In a preferred embodiment, the polymer composite may be prepared by mixing about 70 to 90 wt % of the matrix composite and about 10 to 30 wt % of the filler composite and extrusion-molding the mixture, wherein wt % are based on the total weight of the polymer composite material.

According to various embodiments, the composite material for shielding broadband electromagnetic waves according to the present invention efficiently shields broadband electromagnetic waves including low frequency and high frequency electromagnetic waves, and particularly has excellent electromagnetic absorbing capabilities by improving dispersibility of magnetic particles.

According to another aspect, the present invention provides a method for forming a composite material for shielding broadband electromagnetic waves, the method comprising mixing a matrix composite with a filler composite. In particular, the matrix composite can be prepared by impregnating a matrix-forming polymer with a carbonaceous conductive nano material, and the filler composite can be prepared by impregnating a filler-forming polymer with a magnetic material. According to various embodiments, the magnetic material impregnated in the filler-forming polymer is distributed in the matrix composite.

Other aspects and preferred embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 schematically shows a process of manufacturing a composite material for shielding broadband electromagnetic waves according to an embodiment of the present invention;

FIG. 2 is a scanning electron microscope (SEM) image of a cross-section of a composite material for shielding broadband electromagnetic waves according to an embodiment of the present invention; and

FIG. 3 is a graph illustrating electromagnetic wave shielding capability of a composite material for shielding broadband electromagnetic waves according to an embodiment of the present invention.

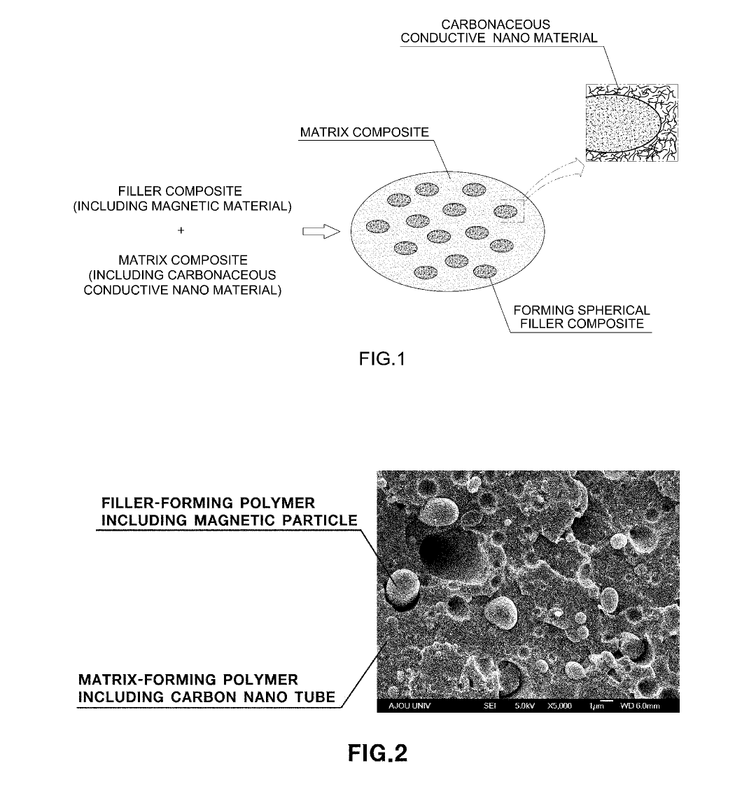

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Ranges provided herein are understood to be shorthand for all of the values within the range. For example, a range of 1 to 50 is understood to include any number, combination of numbers, or sub-range from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

Hereinafter, a composite material for shielding broadband electromagnetic waves according to an embodiment of the present invention will be described in detail.

According to an embodiment of the present invention, the composite for shielding broadband electromagnetic waves is a polymer composite that includes a material for absorbing low frequency electromagnetic waves and a material for reflecting high frequency electromagnetic waves. In particular, the material for absorbing low frequency electromagnetic waves may be a magnetic material, and the material for reflecting high frequency electromagnetic waves may be a carbonaceous conductive nano material. The magnetic material and the carbonaceous conductive nano material may be contained in a polymer resin that is a main matrix material (hereinafter, referred to as matrix-forming polymer). According to various embodiment, the composite material may be manufactured into its desired form by using an extrusion molding process. As referred to herein, “low frequency electromagnetic waves” generally refers to frequencies up to about 300 kHz, particularly frequencies ranging from about 30 kHz-300 kHz. As referred to herein, “high frequency electromagnetic waves” generally refers to frequencies of at least about 3 MHz, particularly frequencies ranging from about 3 MHz-30 MHz.

According to an embodiment, in order to uniformly disperse the magnetic material in the matrix-forming polymer, a filler composite prepared by impregnating a filler-forming polymer (i.e., a material for a matrix of the filler composite) with the magnetic material is used with a mixture of different polymers.

In particular, the filler composite is a composite in which magnetic particles are impregnated in the filler-forming polymer. In order to impregnate the filler-forming polymer with the magnetic material, the filler-forming polymer is mixed with the magnetic material and the mixture is extrusion-molded.

According to various embodiments, the filler-forming polymer and the matrix-forming polymer are thermoplastic polymers. The filler-forming polymer may be any polymer that is hardly mixed with the matrix-forming polymer due to low compatibility, and the matrix-forming polymer may be any material that has low compatibility with the filler-forming polymer. For example, according to an exemplary embodiment, the filler-forming polymer may be polyamide 6, and the matrix-forming polymer may be polypropylene.

As such, the filler-forming polymer and the matrix-forming polymer, which are thermoplastic polymers and melt at a temperature greater then their melting points, are not mixed in their melted states. Rather, the filler-forming polymer and the matrix-forming polymer exist in two different phases. Of these two different polymers having low compatibility, one polymer is used in a relatively large quantity as the matrix-forming polymer, and the other polymer is used in a relatively small quantity as the filler-forming polymer.

Thus, the matrix-forming polymer and the filler-forming polymer may be any combination of a variety of different polymers that exist in two different phases in their melted states due to low compatibility therebetween. For example, a combination of polypropylene and polyethylene, a combination of polypropylene and polyvinyl chloride, and a combination of polyethylene and most polymers, such as, acrylonitrile butadiene styrene copolymer (ABS), polyamide (PA), polycarbonate (PC), polyethylene terephthalate (PET), polymethyl methacrylate (PMMA), polyphenylene oxide (PPO), polystyrene (PS), polyvinyl chloride (PVC), and styrene acrylonitrile copolymer (SAN). For reference, polyethylene hardly mixes with most polymers, including, for example, ABS, PA, PC, PET, PMMA, PPO, PS, PVC, and SAN due to low compatibility therewith.

As such, the matrix-forming polymer may be a thermoplastic polymer in which the filler-forming polymer may be dispersed, (for example, one or more selected from the group consisting of polyethylene, polypropylene, polyvinyl chloride, ABS, PA, PC, PET, PMMA, PPO, PS, PVC, SAN, and mixtures thereof), and the filler-forming polymer may be a thermoplastic polymer dispersible in the matrix-forming polymer (for example, one or more selected from the group consisting of polyethylene, polypropylene, polyvinyl chloride, ABS, PA, PC, PET, PMMA, PPO, PS, PVC, SAN, and mixtures thereof), but wherein the two materials exist in two different phases in their melted states.

According to various embodiments, the content of the magnetic material impregnated in the filler-forming polymer may be equal to or less than about 50 wt %, and more preferably equal to or less than about 45%, about 40%, about 35%, about 30%, about 25%, or about 20 wt %.

According to an exemplary embodiment, the filler composite is prepared by mixing about 50 to 90 wt % of the filler-forming polymer and about 10 to 50 wt % of the magnetic material.

If the content of the magnetic material is less than 10 wt %, effect of shielding electromagnetic waves may deteriorate, so that desired electromagnetic wave absorbing performance may not be obtained. On the other hand, if the content of the magnetic material is greater than 50 wt %, it becomes difficult to mix the filler-forming polymer with the magnetic particles such that additives may become necessary.

The prepared filler composite (filler-forming polymer including the magnetic material) may be mixed with the matrix-forming polymer including the carbonaceous conductive nano material by an extrusion molding process to prepare a polymer composite, i.e., composite for shielding broadband electromagnetic waves.

In this regard, the particulate size of the filler composite is preferably equal to or less than about 10 μm. In particular, it is preferred that the filler composite is formed of spherical particles having a size in the range of about 1 to 10 μm. Of course, it is understood that reference to spherical particles does not only relate to particles that are considered perfectly spherical in overall shape, but also those which would be considered generally spherical-like or near-spherical in their overall shape. As such, the particle size refers to a diameter of the particles. In the case of a generally spherical-like or near-spherical particle, the largest dimension of the cross section of the particle can be used to approximate the diameter for this purpose.

According to embodiments of the invention, the size of the filler composite can be determined by a ratio of the matrix-forming polymer to the filler composite. If the content of the filler composite is equal to or less than about 40 wt % based on the total weight of the polymer composite (composite for shielding broadband electromagnetic waves), then the filler composite is formed as spherical filler particles and is dispersed in the matrix-forming polymer.

In other words, when the content of the filler composite is equal to or less than about 40 wt % based on the total weight of the polymer composite, then spherical particles having a size in the range of about 1 to 10 μm are formed in the matrix-forming polymer. Accordingly, the filler composite including the magnetic material is uniformly dispersed in the matrix-forming polymer to improve dispersibility. As a result, electromagnetic wave absorbing performance of the polymer composite is improved.

According to the present invention, the magnetic material is a material that efficiently shields broadband electromagnetic waves in the range of about 10 MHz to 50 GHz, particularly, in a band of low frequencies. Since a ferromagnetic material is impregnated in the spherical filler-forming polymer while the filler composite is mixed with the matrix-forming polymer, the filler composite is uniformly distributed in the matrix-forming polymer. As a result, uniformity of electromagnetic wave shielding performance of the polymer composite is improved.

If the content of the filler composite is greater than about 40 wt % based on the total weight of the polymer composite, then the filler composite is not be formed in spherical particles, but rather has a continuous phase with the matrix-forming polymer while the matrix-forming polymer is mixed with the filler composite. As a result, the filler composite is not uniformly distributed within the matrix-forming polymer.

Preferably, the content of the filler composite may be in the range of about 10 to 30 wt % based on the total weight of the polymer composite.

Examples of the magnetic material of the filler composite include, but are not limited to, ferromagnetic materials selected from the group consisting of iron, cobalt, nickel, oxides thereof, alloys thereof, and mixtures thereof.

In addition, the magnetic material may have a particle size smaller than the spherical filler composite. For example, the magnetic material may have a particle size of equal to or less than about 5 μm, and may preferably range from about 0.1 to 5 μm.

If the particle size of the magnetic material is greater than the particle size of the spherical filler composite, and particularly if the particle size is greater than about 5 μm, then the magnetic material is not contained within the spherical filler composite.

In addition, according to embodiments of the present invention, the matrix-forming polymer may include a carbonaceous conductive nano material. As such, the polymer composite (composite for shielding broadband electromagnetic waves) may have electromagnetic wave shielding capability using both conductivity and magnetism.

In this regard, the carbonaceous conductive nano material may be carbon nano tube and/or a carbon nano fiber. Further, the carbonaceous conductive nano material may be connected to the spherical filler composite in the matrix-forming polymer.

According to various embodiments, the carbon nano tube may be selected from single-wall carbon nano tubes, double-wall carbon nano tubes, multi-wall carbon nano tubes, and mixtures thereof.

In addition, in consideration of the desired mechanical properties of the polymer composite, the content of the carbonaceous conductive nano material contained in the matrix-forming polymer may be equal to or less than about 20 wt % based on the total weight of the matrix-forming polymer (hereinafter, referred to as ‘matrix composite’) including the carbonaceous conductive nano material for forming a conductive channel in the matrix-forming polymer.

The thus prepared composite for shielding broadband electromagnetic waves allows heat generated when electromagnetic waves are absorbed by the magnetic material to rapidly radiate outward through the carbonaceous conductive nano material.

As such, due to conductivity provided by impregnating the matrix-forming polymer with the carbonaceous conductive nano material, electromagnetic waves may be efficiently shielded in a band of high frequencies by reflecting.

According to embodiments of the present invention, the composite for shielding broadband electromagnetic waves may be prepared by separately preparing the filler composite including the magnetic material, and the matrix composite including the carbonaceous conductive nano material. Thereafter, the filler composite can be mixed with the matrix composite. Alternatively, the filler composite can be prepared including the magnetic material, and then the matrix-forming polymer with the carbonaceous conductive nano material can together be impregnated with the filler composite.

According to an exemplary embodiment, the composite for shielding broadband electromagnetic waves is prepared by mixing about 70 to 90 wt % of the matrix composite (a matrix-forming polymer including the carbonaceous conductive nano material) and about 10 to 30 wt % of the filler composite, wherein the matrix composite is prepared by mixing about 80 to 90 wt % of the matrix-forming polymer and about 10 to 20 wt % of the carbonaceous conductive nano material.

As described above, the composite for shielding broadband electromagnetic waves according to embodiments of the present invention is a polymer composite that includes: a matrix composite including a carbonaceous conductive nano material; and a filler composite including a magnetic material. The composite for shielding broadband electromagnetic waves can absorb electromagnetic waves by the magnetic material and reflect electromagnetic waves by the carbonaceous conductive nano material in a broadband of frequencies in the range of 10 MHz to 50 GHz. In particular, the composite for shielding broadband electromagnetic waves provides efficient electromagnetic wave shielding capability by absorbing low frequency electromagnetic waves and by reflecting high frequency electromagnetic waves.

Further, according to the present invention, the magnetic particles are uniformly distributed by impregnating the matrix composite with the filler composite including the magnetic material, so that electromagnetic wave shielding capability thereof may be improved.

### EXAMPLES

The following examples illustrate the invention and are not intended to limit the same.

Polyamide 6 was mixed with iron oxide (Fe₃O₄:magnetite) in a weight ratio of 90 (900 g):10 (100 g) (polyamide 6:iron oxide), and the mixture was extrusion-molded to prepare a filler composite including a magnetic material.

Then, polypropylene was mixed with a multi-wall carbon nanotube in a weight ratio of 80 (1,600 g):20 (400 g) (polypropylene:carbon nanotube), and the mixture was extrusion-molded to prepare a matrix composite including a carbonaceous conductive nano material.

Then, the filler composite was mixed with the matrix composite in a weight ratio of 10 (100 g):90 (900 g) (filler composite:matrix composite), and the mixture was extrusion-molded to prepare a polymer composite (composite for shielding broadband electromagnetic waves) having a cross-sectional SEM image as shown in FIG. 2.

### Test Examples

A composite sample for shielding electromagnetic waves was injection-molded to 100*100 mm² using the polymer composite prepared according to the Example (according to the present invention), and the amount of electromagnetic waves blocked in a frequency range of 0.5 to 1.5 GHz was measured using an Agilent E8362B analyzer (an electromagnetic shielding test equipment).

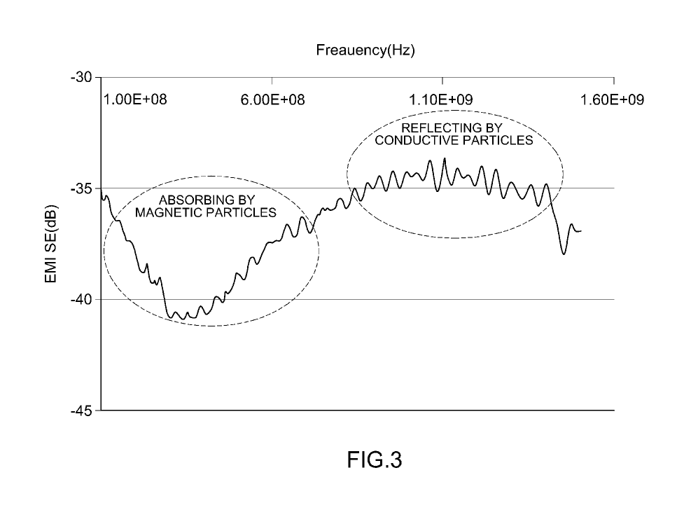

As a result, as shown in FIG. 3, it was demonstrated that electromagnetic wave shielding performance was improved by using the polymer composite prepared according to the Example in a band of low frequencies as compared with a general composite for shielding electromagnetic waves due to the spherical filler composite uniformly dispersed in the polymer composite prepared in the example. In addition, in the composite sample which used the polymer composite prepared according to the Example, electromagnetic waves were reflected by conductivity in a band of high frequencies due to the carbonaceous conductive nano material of matrix-forming polymer. Thus, it was demonstrated that an average of 35 dB or more electromagnetic wave shielding performance may be obtained in all frequencies by using the polymer composite of the present invention.

As described above, the composite for shielding broadband electromagnetic waves according to the present invention can shield electromagnetic waves in all frequencies including low and high frequencies. In particular, such shielding of electromagnetic waves can be provided by preparing the filler composite including the magnetic material and the filler-forming polymer, and then mixing the filler composite with the matrix-forming polymer impregnated with the carbonaceous conductive nano material when the matrix-forming polymer is impregnated with the magnetic material and the carbonaceous conductive nano material.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A composite material for shielding broadband electromagnetic waves comprising:
a polymer composite comprising a mixture of a matrix composite prepared by impregnating a matrix-forming polymer with a carbonaceous conductive nano material, and a filler composite prepared by impregnating a filler-forming polymer with a magnetic material,
wherein the magnetic material impregnated in the filler-forming polymer is distributed in the matrix composite.

2. The composite of claim 1, wherein the matrix-forming polymer and the filler-forming polymer are thermoplastic polymers do not mix in their melted states and exist in two different phases, wherein the polymer composite comprises a combination of at least two types of polymers such that the filler-forming polymer is dispersible in the matrix-forming polymer.

3. The composite of claim 1, wherein the matrix-forming polymer is a thermoplastic polymer in which the filler-forming polymer is dispersible and comprises one or more polymers selected from the group consisting of polyethylene, polypropylene, polyvinyl chloride, acrylonitrile butadiene styrene copolymer (ABS), polyamide (PA), polycarbonate (PC), polyethylene terephthalate (PET), polymethyl methacrylate (PMMA), polyphenylene oxide (PPO), polystyrene (PS), polyvinyl chloride (PVC), styrene acrylonitrile copolymer (SAN), and mixtures thereof.

4. The composite of claim 1, wherein the filler-forming polymer is a thermoplastic polymer dispersible in the matrix-forming polymer and comprises one or more polymer selected from the group consisting of polyethylene, polypropylene, polyvinyl chloride, acrylonitrile butadiene styrene copolymer (ABS), polyamide (PA), polycarbonate (PC), polyethylene terephthalate (PET), polymethyl methacrylate (PMMA), polyphenylene oxide (PPO), polystyrene (PS), polyvinyl chloride (PVC), styrene acrylonitrile copolymer (SAN), and mixtures thereof.

5. The composite of claim 1, wherein the polymer composite comprises a mixture of about 70 to 90 wt % of the matrix composite and about 10 to 30 wt % of the filler composite based on total wt % of the polymer composite.

6. The composite of claim 1, wherein the filler composite comprises a mixture of about 50 to 90 wt % of the filler-forming polymer and about 10 to 50 wt % or the magnetic material based on total wt % of the filler composite.

7. The composite of claim 1, wherein the matrix composite comprises a mixture of about 80 to 90 wt % of the matrix-forming polymer and about 10 to 20 wt % of the carbonaceous conductive nano material based on total wt % of the matrix composite.

8. The composite of claim 1, wherein the filler composite dispersed in the matrix composite is a spherical particle with a size in the range of about 1 μm to about 10 μm.

9. The composite of claim 1, wherein the magnetic material is selected from the group consisting of iron, cobalt, nickel, oxides thereof, alloys thereof and mixtures thereof.

10. The composite of claim 1, wherein the magnetic material has a particle size in the range of about 0.1 to about 5 μm.

11. The composite of claim 1, wherein the carbonaceous conductive nano material comprises a carbon nano tube and a carbon nano fiber.

12. The composite of claim 11, wherein the carbon nanotube is selected from the group consisting of a single-wall carbon nanotube, a double-wall carbon nanotube, a multi-wall carbon nanotube, and mixtures thereof.

13. A method for forming a composite material for shielding broadband electromagnetic waves comprising:
impregnating a matrix-forming polymer with a carbonaceous conductive nano material to form a matrix composite;
impregnating a filler-forming polymer with a magnetic material to form a filler composite;
mixing the matrix composite and the filler composite to form a polymer composite, wherein the magnetic material impregnated in the filler-forming polymer is distributed in the matrix composite.

14. The method of claim 13, wherein the matrix-forming polymer and the filler-forming polymer are thermoplastic polymers do not mix in their melted states and exist in two different phases.

15. The method of claim 13, wherein the step of mixing the matrix composite and the filler composite comprises mixing about 70 to 90 wt % of the matrix composite and about 10 to 30 wt % of the filler composite.

16. The method of claim 13, wherein the step of impregnating the filler-forming polymer with the magnetic material comprises mixing about 50 to 90 wt % of the filler-forming polymer and about 10 to 50 wt % or the magnetic material based on total weight of the filler composite, and the step of impregnating the matrix-forming polymer with the carbonaceous conductive nano material comprises mixing about 80 to 90 wt % of the matrix-forming polymer and about 10 to 20 wt % of the carbonaceous conductive nano material based on total wt % of the matrix composite.
